(19) United States
(12) Patent Application Publication
(10) Pub. No.: US 2026/0154283 A1
(43) Pub. Date: Jun. 4, 2026

(54) METHOD, APPARATUS, DEVICE, STORAGE MEDIUM AND PROGRAM PRODUCT FOR INFORMATION INTERACTION

(71) Applicant: Beijing Zitiao Network Technology Co., Ltd., Beijing (CN)

(72) Inventors: Mian LIU, Beijing (CN); Weiwei XUE, Beijing (CN); Lin TIAN, Beijing (CN); Jiaqi MA, Beijing (CN); Situ FENG, Beijing (CN)

(21) Appl. No.: 19/306,954

(22) Filed: Aug. 21, 2025

(30) Foreign Application Priority Data
Nov. 29, 2024 (WO) PCT/CN2024/135967

(51) Int. Cl. G06F 16/248; G06F 3/0481; H04L 51/02

(52) U.S. Cl. CPC G06F 16/248; G06F 3/0481; H04L 51/02

(57) ABSTRACT

Embodiments of the disclosure provide a method, apparatus, device, a storage medium and a program product for information interaction. The method includes: presenting, in response to receiving a query item, a set of virtual objects matching the query item in a search interface; and presenting, in response to receiving a first operation on a first virtual object of the set of virtual objects, a chat interface associated with a target virtual object, wherein the chat interface is associated with the first virtual object, and the first virtual object is configured to provide response content in the chat interface.

### CROSS-REFERENCE

This application claims the benefit of priority of PCT application No. PCT/CN2024/135967, filed on Nov. 29, 2024, entitled “Method, Apparatus, Device, Storage Medium and Program Product for Information Interaction”, which is incorporated herein by reference in its entirety.

### FIELD

Example embodiments of the present disclosure generally relate to the field of computers, and in particular, to a method, apparatus, device, computer-readable storage medium and computer program product for providing information interaction.

### BACKGROUND

With the development of computer technologies, people may obtain various types of applications by using the Internet. For example, people may create, post, or obtain applications such as agents, bot programs, and the like. Such applications can provide different processing capabilities based on the developer's configuration information.

### SUMMARY

In a first aspect of the present disclosure, a method for information interaction is provided. The method includes: presenting, in response to receiving a query item, a set of virtual objects matching the query item in a search interface; and presenting, in response to receiving a first operation on a first virtual object of the set of virtual objects, a chat interface associated with a target virtual object, wherein the chat interface is associated with the first virtual object, and the first virtual object is configured to provide response content in the chat interface.

In a second aspect of the present disclosure, an apparatus for information interaction is provided. The apparatus includes an object presenting module configured to present, in response to receiving a query item, a set of virtual objects matching the query item in a search interface; and an interface presenting module configured to present, in response to receiving a first operation on a first virtual object of the set of virtual objects, a chat interface associated with a target virtual object, wherein the chat interface is associated with the first virtual object, and the first virtual object is configured to provide response content in the chat interface.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium having a computer program stored thereon, wherein the computer program, when executed by the processor, implements the method of the first aspect.

In a fifth aspect of the present disclosure, a computer program product is provided. The computer program product includes computer executable instructions, wherein the computer executable instructions, when executed by a processor, implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A-2E illustrate schematic diagrams of interfaces according to some embodiments of the present disclosure:

FIG. 3 illustrates a flowchart of a process of information interaction according to some embodiments of the present disclosure:

FIG. 4 illustrates a schematic structural block diagram of an apparatus for information interaction according to some embodiments of the present disclosure:

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first.” “second.” and the like may refer to different or identical objects. Other explicit and implicit definitions may also be included below:

Embodiments of the present disclosure may relate to data of a user, acquisition and/or use of data, and the like. These aspects all follow the corresponding laws and regulations and related rules. In the embodiments of the present disclosure, all data is collected, obtained, processed, manufactured, forwarded, used, etc., all of which are performed on the premise that the user knows and confirms. Accordingly, when implementing various embodiments of the present disclosure, the types, the usage scope, the usage scenario, and the like of the data or information that may be involved, should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, does not affect the basic function of the user.

In recent years, the number of virtual objects such as agents, robot programs and the like is increasing. Different virtual objects have a large difference in processing performance in different processing scenarios. This allows the user to make multiple attempts to obtain the virtual object expected to be used, which greatly affects the processing efficiency of the information.

In view of this, embodiments of the present disclosure provide a solution for information interaction. According to the scheme, in response to receiving a query item, a set of virtual objects matching the query item is presented in a search interface; and in response to receiving a first operation on a first virtual object of the set of virtual objects, a chat interface associated with a target virtual object is presented, wherein the chat interface is associated with the first virtual object, and the first virtual object is configured to provide response content in the chat interface.

Based on such a manner, the embodiments of the present disclosure can present a matching virtual object based on the search request of the user, and can support the user in initiating interaction with the virtual object in the unified chat interface. Therefore, the embodiments of the present disclosure can improve the interaction efficiency with the virtual object.

### Example Environment

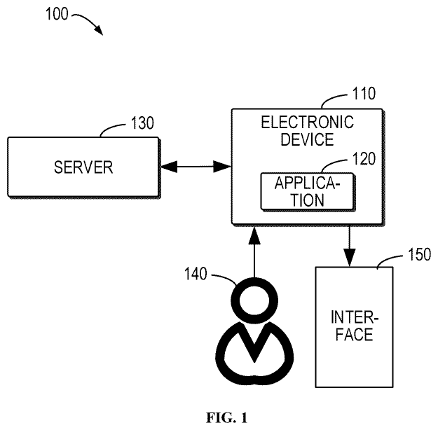

FIG. 1 illustrates a schematic diagram of an example environment 100 in which embodiments of the present disclosure can be implemented. As shown in FIG. 1, the example environment 100 may include an electronic device 110.

In this example environment 100, an application 120 is installed in the electronic device 110. The user 140 may interact with the application 120 via the electronic device 110 and/or its attachment device. The application 120 may be an integrated development environment application, or any other suitable application.

In the environment 100 of FIG. 1, if the application 120 is in an active state, the application 120 may provide a presentation interface 150 for the user 140.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support content presentation in the electronic device 110.

A communication connection may be established between the server 130 and the electronic device 110. The communication connection may be established in a wired manner or a wireless manner. Communication connections may include, but are not limited to. Bluetooth connections, mobile network connections, universal serial bus connections, wireless fidelity connections, etc., embodiments of the present disclosure are not limited in this respect. In an embodiment of the present disclosure, the server 130 and the electronic device 110 may implement signaling interaction through a communication connection between the server 130 and the electronic device 110.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### Example Interaction

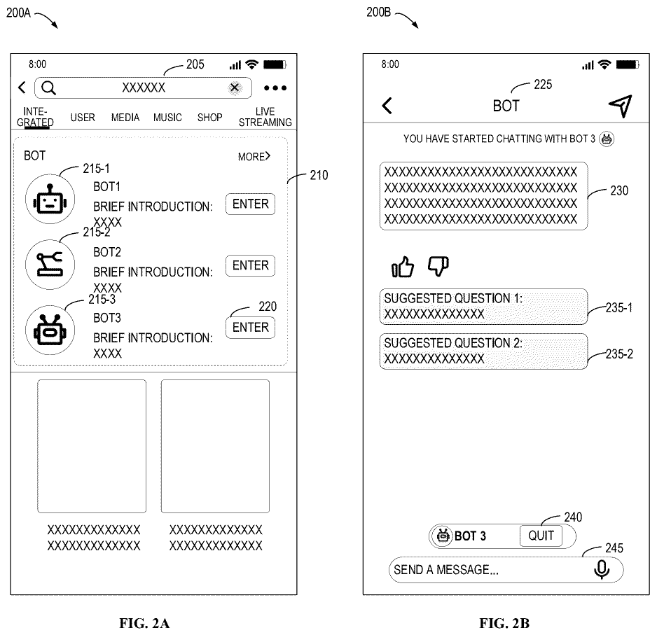

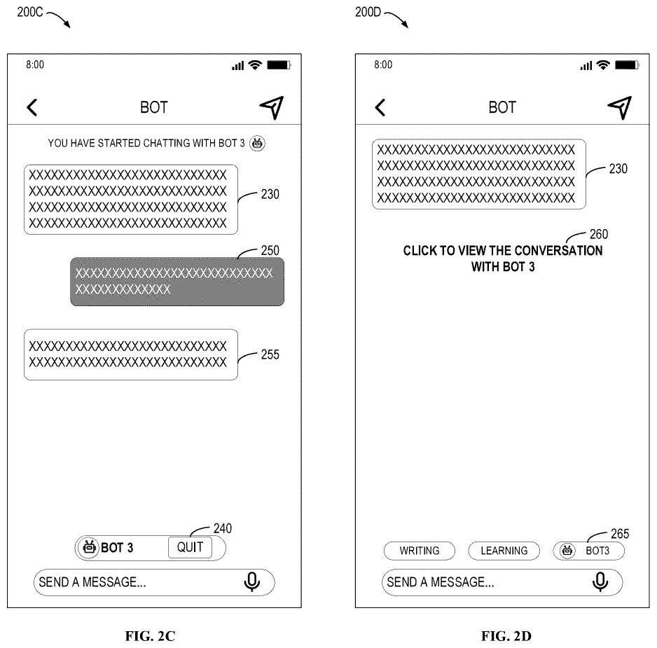

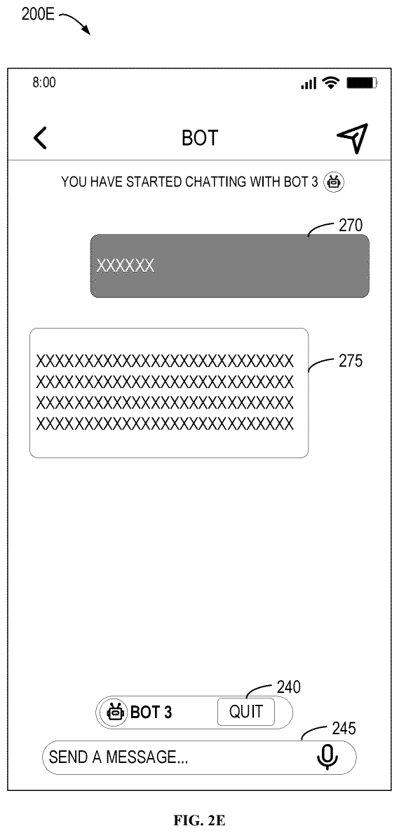

An example interaction process according to embodiments of the present disclosure will be described below with reference to FIGS. 2A-2E. FIGS. 2A-2E illustrate example interfaces 200A-200E, which may be provided by the electronic device 110 shown in FIG. 1, for example, in accordance with some embodiments of the present disclosure.

FIG. 2A illustrates a search interface 200A according to some embodiments of the present disclosure. As shown in FIG. 2A, the electronic device 110 may, for example, receive a search request of a user, and may display the search interface 200A accordingly.

As shown in FIG. 2A, a user's search request may be associated with query item 205. As an example, the query item 205 may include, for example, keywords.

In some examples, the user may input the query item 205 through a search control, for example. Alternatively, the user may also select a target search term from candidate search terms as the query item 205.

In other embodiments, the query item 205 may also be automatically determined, for example, based on an interaction operation of the user. For example, the electronic device 110 or the server 130 may automatically determine the query item 205 based on context information of the interaction operation.

In some embodiments, as shown in FIG. 2A, the electronic device 110 may provide a component 210 for displaying a virtual object in a search interface 200A. The component 210 may, for example, present a set of virtual objects matching the query item 205.

As an example, a set of virtual objects may include one or more virtual objects determined with the query item 205, e.g., virtual object 215-1, virtual object 215-2, or virtual object 215-3 (individually or collectively referred to as a virtual object 215).

In some scenarios, the virtual object 215 may also be referred to as a digital object or a virtual entity. As an example, each virtual object 215 may include an agent, a bot, or other suitable object. Such a virtual object 215 may, for example, process the received request based on a model or workflow. As an example, the virtual object 215 may accept an input message of a user and may accordingly generate a response content related to the input message based on configuration information.

In some embodiments, the virtual object may also utilize an appropriate model to implement processing and/or generation of the content. Such a model may include any suitable machine learning model, such as a generative model. In the present disclosure, the generation operation performed by the virtual object may be actually performed with an appropriate model and/or application corresponding to the virtual object.

As shown in FIG. 2A, the component 210 may display at most a predetermined number of virtual objects 215. If the number of virtual objects 215 matching the query item 205 exceeds the predetermined number, the user may view all of the virtual objects, for example, by clicking on “more”.

In some embodiments, the display order of the virtual objects 215 in the component 210 may be determined based on a degree of matching between the virtual object 215 and the query item 205, for example. Alternatively or in addition, the display order of the virtual objects 215 in the component 210 may be determined based on the interaction information (for example, the number of invocations) corresponding to the virtual object 215.

In addition, the component 210 may also present identification information of the virtual object 215, for example, a text identifier (name) and an image identifier (for example, an icon). Additionally, the component 210 may also present description information, e.g., profile content, of the virtual object 215.

The electronic device 110 may further receive a first operation of the user on the virtual object 215-3. For example, the electronic device 110 may receive a user's click on the icon or control 220. Accordingly, the electronic device 110 may, for example, present an interface 200B as shown in FIG. 2B.

As shown in FIG. 2B, the interface 200B may correspond to a chat interface with target virtual object 225. In some embodiments, the target virtual object 225 is different from the virtual object 215 presented in the component 210. As an example, the target virtual object 225 may be associated with an application 120 providing the search interface 200A, which may be, for example, a platform virtual object configured in the application 120.

As shown in FIG. 2B, the virtual object 215-3 selected by the user may be associated to the chat interface 200B, which causes the selected virtual object 215-3 to be configured to provide the response content in the chat interface 200B.

As an example, the electronic device 110 may provide an opening message 230 (also referred to as an opening remarks) associated with the virtual object 215-3 in the chat interface 200B. Additionally, the electronic device 110 may also present one or more suggested input items associated with the virtual object 215-3, such as the suggested question 235-1 and the suggested question 235-2. As an example, the user may, for example, select the suggested question 235-1 to quickly interact with the virtual object 215-3.

In some embodiments, the suggested question 235-1 and the suggested question 235-2 may be generated based on the query item 205, for example. In this way, embodiments of the present disclosure may improve interaction efficiency with a virtual object.

In addition, as shown in FIG. 2B, the electronic device 110 may further display an indication element 240 associated with the virtual object 215-3 in the chat interface 200B. As an example, the indication element 240 may characterize that the virtual object 215-3 is currently associated with chat interface 200B, and the virtual object 215-3 is being configured to generate the response content in the chat interface. As another example, the electronic device 110 may also display “you have started chatting with BOT3” at a top location in the conversation interface 200B to indicate that the virtual object 215-3 is currently associated with the conversation interface 200B, for example.

As an example, the electronic device 110 may receive a first message input by the user via the input control 245. As shown in FIG. 2C, the electronic device 110 may receive the first message 250 input by the user, and may accordingly present the second message 255 generated by the virtual object 215-3 based on the first message 250.

In this way, embodiments of the present disclosure may support a user in initiating an interaction with other virtual objects in a unified chat interface, thereby improving efficiency of message interaction.

In some embodiments, the electronic device 110 may further receive a second operation on the indication element 240 by the user, and may trigger disassociating the virtual object 215-3 from the chat interface. As an example, the electronic device 110 may receive a user's click on an “exit” button in the indication element 240 and may accordingly present the interface 200D as shown in FIG. 2D.

As shown in FIG. 2D, after the virtual object 215-3 disassociates with the chat interface, the electronic device 110 may stop displaying a set of messages associated with the virtual object 215-3 in chat interface 200D. e.g., message 250 and message 255 shown in FIG. 2C. For example, the electronic device 110 may fold one or more rounds of conversation messages with the virtual object 215-3.

Further, the electronic device 110 may also correspondingly provide an entry 260 for viewing the set of messages. The electronic device 110 may: for example, receive a trigger for the entry 260 and expand a set of messages associated with the virtual object 215-3 accordingly in the chat interface 200D.

In this way, after the user exits the interaction with the virtual object 215-3, the embodiments of the present disclosure can reduce the degree of influence of the conversation messages related to the virtual object 215-3 on subsequent conversation interaction in the chat interface.

In some embodiments, as shown in FIG. 2D, the electronic device 110 may also present a tool entry 265 corresponding to the virtual object 215-3 in the chat interface 200D. In particular, the tool entry 265 may be configured to trigger a re-association of the chat interface to the virtual object 215-3.

As an example, the electronic device 110 may receive a selection of the tool entry 265 and may associate the virtual object 215-3 to the chat interface and may re-expand the folded conversation message associated with the virtual object 215-3.

In some embodiments, the electronic device 110 may present a plurality of tool entries in a tool area. Such a tool entry may be associated with a virtual object or may be associated with other tool components. As an example, the tool area may include, for example, a plurality of slots, and more tool entries may be presented based on the user's swiping operation.

In some embodiments, the ordering of the plurality of tool entries in the tool area may be determined based on a frequency and/or chronological order of invoking corresponding tool components (e.g., virtual objects) in the chat interface. For example, the tool entry corresponding to the tool component with the highest frequency may be ordered first: or the tool entry corresponding to the last invoked tool component may be ordered first.

Example interaction processes in accordance with some embodiments of the present disclosure are described above with reference to FIGS. 2B-2D. In some scenarios, the electronic device 110 may present the chat interface 200E as shown in FIG. 2E, for example, based on the selection of the virtual object 215-3.

As shown in FIG. 2E, unlike the interface 200B shown in FIG. 2B, the electronic device 110 may present, in the chat interface 200E, a third message 270 corresponding to the query item 205. Further, the electronic device 110 may also provide the fourth message 275 generated by the virtual object 215-3 based on the third message 270 in the chat interface.

In some embodiments, the third message 270 may include, for example, a query item 205. Alternatively, the third message 270 may also be generated based on the query item 205. For example, the third message 270 may be text content generated by rewriting the query item 205 with a language model.

In some embodiments, the electronic device 110 or the server 130 may determine whether the query item 205 satisfies a preset condition to determine whether to directly send the third message corresponding to the query item 205 to the virtual object 215-3. As an example, the preset condition may be related to semantic content of the query item 205. If the query item 205 expresses a requirement to be processed, the question corresponding to the query item 205 may be sent to the virtual object 215-3.

As an example, the query item 205 may include “how is the weather today”. Accordingly, the virtual object 215-3 may be, for example, an agent or Bot with weather query capability: In this case, the query item 205 may be directly provided to the virtual object 215-3 as a third message, such that the virtual object 215-3 may feedback the corresponding weather information.

In this way, the embodiments of the present disclosure may further improve the interaction efficiency of the user, and reduce the interaction cost of the user by quickly initiating the query.

The specific process of determining a set of virtual objects 215 based on the query item 205 will be explained further below:

In some embodiments, the server 130 may, for example, obtain description information associated with the plurality of candidate virtual objects, and may determine a group of virtual objects from the plurality of candidate virtual objects based on the comparison of the query items 205 and the description information.

As an example, the plurality of candidate virtual objects may be determined from a set of virtual objects supported by the application 120 or a set of virtual objects supported for invocation by the target virtual object 225.

Further, the server 130 may further construct description information corresponding to the plurality of candidate virtual objects based on reference information associated with the plurality of candidate virtual objects. As an example, such description information may include a set of keywords matching each candidate virtual object.

In some embodiments, the server 130 may, for example, utilize the model to process reference information associated with the candidate virtual object to generate a first keyword set associated with the candidate virtual object. As an example, the reference information may, for example, indicate various description items associated with candidate virtual objects (e.g., agents or Bot).

In some embodiments, the reference information may include, for example, identification information of the candidate virtual object, for example, a name of Bot. Additionally or alternatively, the reference information may also include summary information of the candidate virtual object, e.g., description text of Bot. Additionally or alternatively; the reference information may further include opening information configured for the candidate virtual object. As an example, the server 130 may determine the above reference information from the configuration information of the candidate virtual object, for example.

In some embodiments, the reference information may further include, for example, a preset search term associated with the candidate virtual object. For example, such search terms are associated with a search service for the recall of the candidate virtual object.

Further, the server 130 may, for example, provide the above reference information to a language model to instruct the language model to generate the first keyword set based on the reference information. Additionally, in order to improve the coverage rate of the keyword, the server 130 may further obtain at least one additional keyword associated with the first keyword set.

As an example, the server 130 may determine a feature representation of each keyword in the first keyword set, and may determine, from the keyword library; one or more additional keywords similar to the feature representation, thereby realizing an expansion of the keyword.

Correspondingly; the server 130 may construct the second keyword set based on the first keyword set and the at least one additional keyword as the description information corresponding to each candidate virtual object.

Further, in the search process, the server 130 may, for example, determine whether the keyword set corresponding to each candidate virtual object includes the query item 205. If the keyword set includes a query item 205, the server 130 may determine that the query item 205 matches the candidate virtual object.

Based on such a manner, the embodiments of the present disclosure can present the matching virtual object based on the search request of the user, and can support the user in initiating interaction with the virtual object in the unified chat interface. Therefore, the embodiment of the present disclosure can improve the interaction efficiency with the virtual object.

### Example Processes

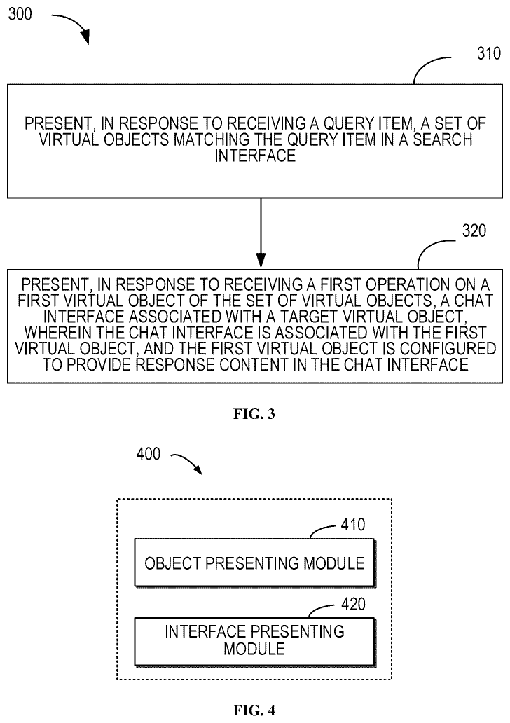

FIG. 3 illustrates a flowchart of a process 300 of information interaction according to some embodiments of the present disclosure. Process 300 may be implemented at the electronic device 110. The process 300 is described below with reference to FIG. 1.

At block 310, the electronic device 110 presents, in response to receiving a query item, a set of virtual objects matching the query item in a search interface.

At block 320, the electronic device 110 presents, in response to receiving a first operation on a first virtual object of the set of virtual objects, a chat interface associated with a target virtual object, wherein the chat interface is associated with the first virtual object, and the first virtual object is configured to provide response content in the chat interface.

In some embodiments, process 300 further includes: receiving, in the chat interface, a first message input by a user; and providing, in the chat interface, a second message generated by the first virtual object based on the first message.

In some embodiments, the process 300 further includes: presenting, in the chat interface, an indication element associated with the first virtual object; and disassociating the chat interface from the first virtual object in response to receiving a second operation on the indication element.

In some embodiments, the process 300 further includes: stopping presenting, in the chat interface, a set of messages associated with the first virtual object in response to disassociating the chat interface from the first virtual object.

In some embodiments, process 300 further includes: presenting, in the chat interface, a viewing entry associated with the set of messages; and presenting, in response to a trigger on the entry, the set of messages associated with the first virtual object in the chat interface.

In some embodiments, the process 300 further includes: presenting, in response to disassociating the chat interface from the first virtual object, a tool entry in the chat interface, the tool entry being configured to trigger reassociation of the chat interface to the first virtual object.

In some embodiments, the process 300 further includes: providing a set of suggested input items in the chat interface, wherein the set of suggested input items are determined based on the query item.

In some embodiments, the process 300 further includes: triggering, in response to the query item satisfying a preset condition, a presentation of a third message corresponding to the query item in the chat interface; and providing, in the chat interface, a fourth message generated by the first virtual object based on the third message.

In some embodiments, the third message includes the query item: or the third message is generated based on the query item.

In some embodiments, the set of virtual objects is determined based on the following process: obtaining description information associated with a plurality of candidate virtual objects; and determining, based on a comparison between the query item and the description information, the set of virtual objects from the plurality of candidate virtual objects.

In some embodiments, obtaining the description information associated with the plurality of candidate virtual objects includes: providing, to a model, reference information associated with a candidate virtual object to generate a first keyword set associated with the candidate virtual object: obtaining at least one additional keyword associated with the first keyword set; and determining a second keyword set based on the first keyword set and the at least one additional keyword as the description information.

In some embodiments, the reference information indicates at least one of the following: identification information of the candidate virtual object: summary information of the candidate virtual object: opening information configured for the candidate virtual object: or a preset search term associated with the candidate virtual object.

### Example Apparatus and Device

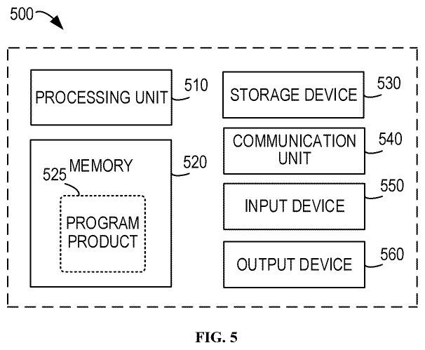

Embodiments of the present disclosure also provide a corresponding apparatus for implementing the above method or process. FIG. 4 is a schematic structural block diagram of an apparatus 400 for information interaction according to some embodiments of the present disclosure. The apparatus 400 may be implemented or included in the electronic device 110 as discussed above. The various modules/components in the apparatus 400 may be implemented by hardware, software, firmware, or any combination thereof.

As shown in FIG. 4, the apparatus 400 includes an object presentation module 410 configured to present, in response to receiving a query item, a set of virtual objects matching the query item in a search interface; and an interface presenting module 420 configured to present, in response to receiving a first operation on a first virtual object of the set of virtual objects, a chat interface associated with a target virtual object, wherein the chat interface is associated with the first virtual object, and the first virtual object is configured to provide response content in the chat interface.

In some embodiments, the apparatus 400 further includes a providing module configured to: receive, in the chat interface, a first message input by a user; and provide, in the chat interface, a second message generated by the first virtual object based on the first message.

In some embodiments, the apparatus 400 further includes a disassociation module configured to: present, in the chat interface, an indication element associated with the first virtual object; and disassociate the chat interface from the first virtual object in response to receiving a second operation on the indication element.

In some embodiments, the apparatus 400 further includes a stopping module configured to: stop presenting, in the chat interface, a set of messages associated with the first virtual object in response to disassociating the chat interface from the first virtual object.

In some embodiments, the apparatus 400 further includes a message presenting module configured to: present, in the chat interface, a viewing entry associated with the set of messages; and present, in response to a trigger on the entry: the set of messages associated with the first virtual object in the chat interface.

In some embodiments, the apparatus 400 further includes a tool entry module configured to: present, in response to disassociating the chat interface from the first virtual object, a tool entry in the chat interface, the tool entry being configured to trigger reassociation of the chat interface to the first virtual object.

In some embodiments, the apparatus 400 further includes a suggestion module configured to: provide a set of suggested input items in the chat interface, wherein the set of suggested input items are determined based on the query item.

In some embodiments, the apparatus 400 further includes a sending module, configured to: trigger, in response to the query item satisfying a preset condition, a presentation of a third message corresponding to the query item in the chat interface; and provide, in the chat interface, a fourth message generated by the first virtual object based on the third message.

In some embodiments, the third message includes the query item: or the third message is generated based on the query item.

In some embodiments, the set of virtual objects is determined based on the following process: obtaining description information associated with a plurality of candidate virtual objects; and determining, based on a comparison between the query item and the description information, the set of virtual objects from the plurality of candidate virtual objects.

In some embodiments, obtaining the description information associated with the plurality of candidate virtual objects includes: providing, to a model, reference information associated with a candidate virtual object to generate a first keyword set associated with the candidate virtual object: obtaining at least one additional keyword associated with the first keyword set; and determining a second keyword set based on the first keyword set and the at least one additional keyword as the description information.

In some embodiments, the reference information indicates at least one of the following: identification information of the candidate virtual object: summary information of the candidate virtual object: opening information configured for the candidate virtual object: or a preset search term associated with the candidate virtual object.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, illustrative types of hardware logic components that may be used includes field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 shown in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data (e.g., training data for training) and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other devices, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for information interaction comprising:
presenting, in response to receiving a query item, a set of virtual objects matching the query item in a search interface; and
presenting, in response to receiving a first operation on a first virtual object of the set of virtual objects, a chat interface associated with a target virtual object, wherein the chat interface is associated with the first virtual object, and the first virtual object is configured to provide response content in the chat interface.

2. The method of claim 1, further comprising:
receiving, in the chat interface, a first message input by a user; and
providing, in the chat interface, a second message generated by the first virtual object based on the first message.

3. The method of claim 1, further comprising:
presenting, in the chat interface, an indication element associated with the first virtual object; and
disassociating the chat interface from the first virtual object in response to receiving a second operation on the indication element.

4. The method of claim 3, further comprising:
stopping presenting, in the chat interface, a set of messages associated with the first virtual object in response to disassociating the chat interface from the first virtual object.

5. The method of claim 4, further comprising:
presenting, in the chat interface, a viewing entry associated with the set of messages; and
presenting, in response to a trigger on the entry, the set of messages associated with the first virtual object in the chat interface.

6. The method of claim 3, further comprising:
presenting, in response to disassociating the chat interface from the first virtual object, a tool entry in the chat interface, the tool entry being configured to trigger reassociation of the chat interface to the first virtual object.

7. The method of claim 1, further comprising:
providing a set of suggested input items in the chat interface, wherein the set of suggested input items are determined based on the query item.

8. The method of claim 1, further comprising:
triggering, in response to the query item satisfying a preset condition, a presentation of a third message corresponding to the query item in the chat interface; and
providing, in the chat interface, a fourth message generated by the first virtual object based on the third message.

9. The method of claim 8, wherein:
the third message comprises the query item: or
the third message is generated based on the query item.

10. The method of claim 1, wherein the set of virtual objects is determined based on the following process:
obtaining description information associated with a plurality of candidate virtual objects; and
determining, based on a comparison between the query item and the description information, the set of virtual objects from the plurality of candidate virtual objects.

11. The method of claim 10, wherein obtaining the description information associated with the plurality of candidate virtual objects comprises:
providing, to a model, reference information associated with a candidate virtual object to generate a first keyword set associated with the candidate virtual object;
obtaining at least one additional keyword associated with the first keyword set; and
determining a second keyword set based on the first keyword set and the at least one additional keyword as the description information.

12. The method of claim 11, wherein the reference information indicates at least one of the following:
identification information of the candidate virtual object;
summary information of the candidate virtual object;
opening information configured for the candidate virtual object: or
a preset search term associated with the candidate virtual object.

13. The method of claim 1, wherein the target virtual object is associated with an application providing the search interface.

14. An electronic device comprising:
at least one processor; and
at least one memory coupled to the at least one processor and storing instructions for execution by the at least one processor, wherein the instructions, when executed by the at least one processor, cause the electronic device to perform acts, comprising:
presenting, in response to receiving a query item, a set of virtual objects matching the query item in a search interface; and
presenting, in response to receiving a first operation on a first virtual object of the set of virtual objects, a chat interface associated with a target virtual object, wherein the chat interface is associated with the first virtual object, and the first virtual object is configured to provide response content in the chat interface.

15. The electronic device of claim 14, wherein the acts further comprise:
receiving, in the chat interface, a first message input by a user; and
providing, in the chat interface, a second message generated by the first virtual object based on the first message.

16. The electronic device of claim 14, wherein the acts further comprise:
presenting, in the chat interface, an indication element associated with the first virtual object; and
disassociating the chat interface from the first virtual object in response to receiving a second operation on the indication element.

17. The electronic device of claim 16, wherein the acts further comprise:
stopping presenting, in the chat interface, a set of messages associated with the first virtual object in response to disassociating the chat interface from the first virtual object.

18. The electronic device of claim 17, wherein the acts further comprise:
presenting, in the chat interface, a viewing entry associated with the set of messages; and
presenting, in response to a trigger on the entry, the set of messages associated with the first virtual object in the chat interface.

19. The electronic device of claim 16, wherein the acts further comprise:
presenting, in response to disassociating the chat interface from the first virtual object, a tool entry in the chat interface, the tool entry being configured to trigger reassociation of the chat interface to the first virtual object.

20. A non-transitory computer-readable storage medium having a computer program stored thereon, wherein the computer program, when executed by a processor, implements acts, comprising:
presenting, in response to receiving a query item, a set of virtual objects matching the query item in a search interface; and
presenting, in response to receiving a first operation on a first virtual object of the set of virtual objects, a chat interface associated with a target virtual object, wherein the chat interface is associated with the first virtual object, and the first virtual object is configured to provide response content in the chat interface.
